(19) United States
(12) Patent Application Publication
(10) Pub. No.: US 2023/0252436 A1
(43) Pub. Date: Aug. 10, 2023

(54) SYSTEM AND METHOD FOR EXTENDING AN INTELLIGENT LINE OF CREDIT FOR AGGREGATING FINANCIAL TRANSACTIONS

(71) Applicant: Percents, Inc. (dba Percents), Seattle, WA (US)

(72) Inventors: Benjamin Taylor, Seattle, WA (US); Phillip Chao, Seattle, WA (US)

(21) Appl. No.: 18/107,403

(22) Filed: Feb. 8, 2023

Related U.S. Application Data
(60) Provisional application No. 63/308,438, filed on Feb. 9, 2022.

(51) Int. Cl. G06Q 20/10; G06Q 20/02; G06Q 20/24

(52) U.S. Cl. CPC G06Q 20/108; G06Q 20/02; G06Q 20/24

(57) ABSTRACT

A system for extending an intelligent line of credit to aggregate financial transactions initiated via a plurality of payment devices associated with a user and methods for making and utilizing the same. The system can determine a first line of credit in real time at initiation of a first financial transaction with a third party via a first payment device, a first credit line amount of the first line of credit being based upon a first financial transaction amount of the first financial transaction. Based upon receipt of a credit authorization from the first payment device, the system can associate the first line of credit with the first payment device and transfer a payment in the first credit line amount from the first line of credit to the third party. The system advantageously can complete the first financial transaction with the third party via the first line of credit.

### CROSS-REFERENCE TO RELATED APPLICATIONS

This application claims the benefit of, and priority to, U.S. Provisional Application Ser. No. 63/308,438, filed on Feb. 9, 2022, the disclosure of which is hereby incorporated herein by reference in its entirety and for all purposes.

### FIELD

The disclosed embodiments relate generally to the field of financial transaction processing and more particularly, but not exclusively, to systems and methods for extending an intelligent line of credit to aggregate financial transactions initiated via a plurality of payment devices associated with a payment device user.

### BACKGROUND

The average consumer has four credit and debit cards according to a 2021 study. Such consumers may accidentally or incorrectly charge purchases to a first card and later want to change or reassign the charge to a second, different card. Conventional financial transaction processes, however, do not permit such reassignments of charges after the purchases have been consummated.

In view of the foregoing, a need exists for a system and method for reassigning a financial transaction from a first payment device to a second device that overcome the aforementioned obstacles and deficiencies of currently-available financial transaction processes.

### BRIEF DESCRIPTION OF THE DRAWINGS

FIG. 1 is a top level flow chart illustrating an exemplary embodiment of a financial transaction revision method.

FIG. 2 is a detail diagram illustrating an exemplary embodiment of a user interface system for the financial transaction revision method of FIG. 1.

FIG. 3 shows an example computer system for implementing the financial transaction revision method of FIG. 1.

FIG. 4 is a top level flow chart illustrating an exemplary embodiment of a financial transaction aggregation method.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

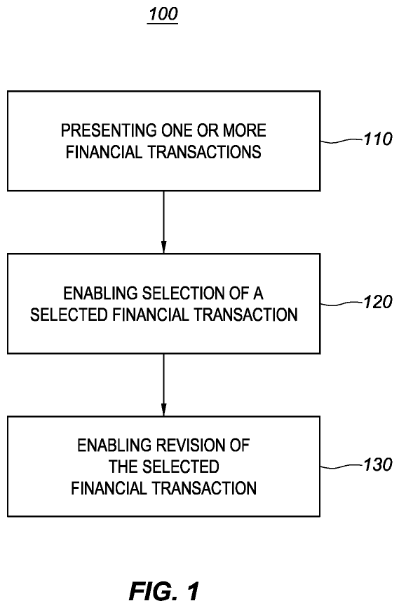

Since conventional financial transaction processes do not permit reassignment of purchases that were accidentally or incorrectly charged to a first card to a second, different card, a financial transaction reassignment system and method for reassigning a financial transaction from a first payment device to a second device after the purchase has been consummated can prove desirable and provide a basis for a wide range of applications, such as credit cards, debit cards and other types of physical and/or digital payment devices. This result can be achieved, according to one embodiment disclosed herein, by a financial transaction revision method 100 as illustrated in FIG. 1.

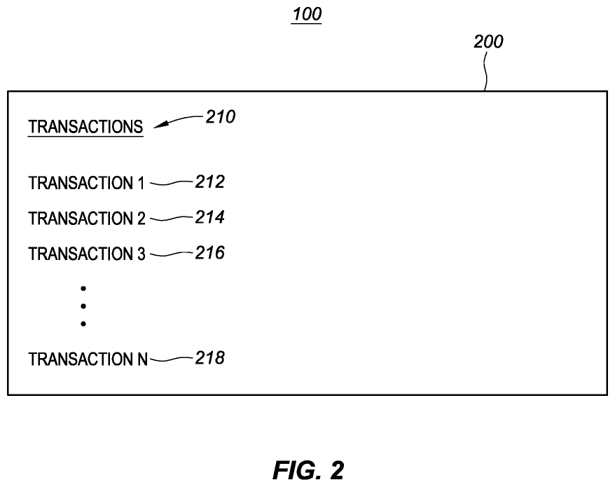

Turning to FIG. 1, the financial transaction revision method 100 is shown as including, at 110, presenting one or more financial transactions 210 (shown in FIG. 2). The presented financial transactions 210, for example, can comprise financial transactions that were previously initiated and/or consummated by a consumer or other payment device user who is associated with two or more credit cards, debit cards and other types of physical and/or digital payment devices. The presented financial transactions 210 can be presented in any suitable manner such as via a user interface system (or circuit) 200 as illustrated in FIG. 2.

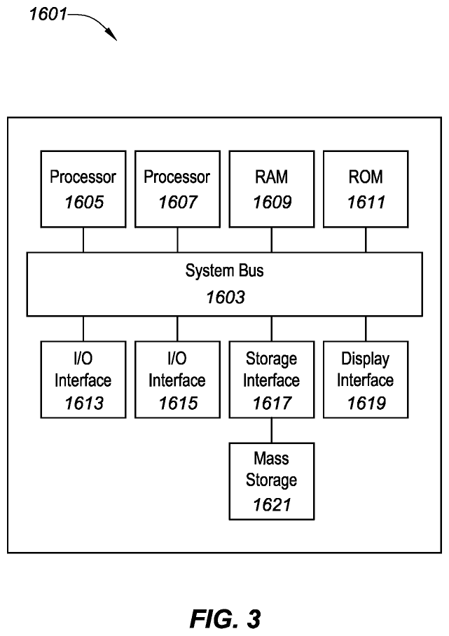

Turning to FIG. 2, the user interface system 200 can comprise a suitable type of user interface system, such as a digital user interface system (or circuit) that can be presented via a display system (or circuit) (not shown) of a processing system (or circuit) (not shown). Exemplary processing systems can include, but are not limited to, a mobile (or smart) telephone device, laptop computer system, and/or a desktop computer system. In selected embodiments, the display system can comprise a display interface system (or circuit) 1619 of a computer (or server) system (or circuit) 1601 as shown and described below with reference to FIG. 3. Additionally and/or alternatively, the presented financial transactions 210 presented on the user interface system 200 can be navigated via a keyboard, mouse, touchscreen or other navigation device of the processing system.

The user interface system 200 can present the presented financial transactions 210 in any predetermined configuration, arrangement, categorization and/or format. The presented financial transactions 210, for example, can be arranged according to transaction date, transaction type, transaction amount and/or sorted by the payment device of the payment device user. The user interface system 200 can enable the payment device user to change or otherwise customize the presentation of the presented financial transactions 210.

The presented financial transactions 210 can be presented textually and/or graphically. Exemplary textual manners for presenting the presented financial transactions 210 can include presenting textual summaries of the presented financial transactions 210; whereas, each presented financial transaction 210 can be presented graphically via at least one icon or other image. Stated somewhat differently, the presented financial transactions 210 can be associated with the icons or other images. As illustrated in FIG. 2, the presented financial transactions 210 can be presented as a listing of a predetermined number n of financial transactions 212, 214, 216, . . . , 218.

Advantageously, the presented financial transactions 210 can be selectable. One or more of the presented financial transactions 210, in other words, can be selected for further review by the payment device user. In selected embodiments, the financial transaction revision method 100 can enable the payment device user to navigate the presented financial transactions 210 and to select one or more of the presented financial transactions 210.

Returning to FIG. 1, the financial transaction revision method 100 can include, at 120, enabling selection of at least one of the presented financial transactions 210, such as the selected financial transaction 214 (shown in FIG. 2). If presented via the user interface system 200 (shown in FIG. 2), the selected financial transaction 214 can be presented in a manner by which the presented financial transactions 210 can be activated for further review. The transaction summary text or icon, for example, can be clickable or otherwise actuatable for accessing the selected financial transaction 214.

In selected embodiments, information about the selected financial transaction 214 can be presented. The information about the selected financial transaction 214, for example, can be presented once the selected financial transaction 214 has been selected. The financial transaction information can comprise detailed information about the selected financial transaction 214. Each selected financial transaction 214 can comprise any conventional type of financial transaction information, such as information related to a purchase, a purchase authorization or other type of financial transaction. Exemplary financial transaction information can include information about goods and/or services being purchased by the payment device user as a part of the selected financial transaction. Exemplary information about the goods and/or services can comprise a purchase quantity, a purchase price, a description of the goods and/or services, a model number of the goods and/or services, an availability of the goods and/or services, a date and/or time of the financial transaction, a shipping and/or delivery deadline for the goods and/or services, a payment term, and/or a duration term, without limitation.

In selected embodiments, the additional information about the selected financial transaction 214 can be presented to the payment device user via the user interface system 200. The user interface system 200 thereby can enable the payment device user to review the selected financial transaction 214.

The financial transaction revision method 100 can enable revision of the selected financial transaction 214, at 130. Stated somewhat differently, the financial transaction revision method 100 thereby can enable the payment device user to revise one or more editable characteristics of the selected financial transaction 214. Exemplary editable characteristics of the selected financial transaction 214 can include, but are not limited, to a description, an expense category, a taxable status, a client or other billing reference number of the selected financial transaction 214.

Advantageously, the financial transaction revision method 100 can enable revision of the payment device to which the selected financial transaction 214 should be applied. In other words, if the selected financial transaction 214 was originally consummated via a first payment device associated with the payment device user, the financial transaction revision method 100 can enable the selected financial transaction 214 to be transferred to a second, different payment device associated with the payment device user.

For example, if the payment device user accidently or otherwise incorrectly charged the selected financial transaction 214 to the first payment device when initiating and/or consummating the selected financial transaction 214, the financial transaction revision method 100 can enable the payment device user to correct this error by permitting the payment device user to later route or otherwise transfer the selected financial transaction 214 from the incorrect first payment device to the correct second payment device. The financial transaction revision method 100 can enable the payment device user to transfer the selected financial transaction 214 from the first payment device to the second payment device even after the selected financial transaction 214 has been consummated via the first payment device.

If the selected financial transaction 214 received an original authorization at the time of consummation, the financial transaction revision method 100 optionally can attend to the authorization with the transfer the selected financial transaction 214 from the first payment device to the second payment device. The financial transaction revision method 100, for example, can cancel the original authorization if the original authorization is uncaptured.

If the original authorization and/or transaction is captured, however, the payment amount of the selected financial transaction 214 can be refunded to the first payment device, and a corresponding new financial transaction and/or authorization can be created for the second payment device. The new financial transaction and/or authorization can include the same transaction details as the selected financial transaction 214 and/or the original authorization, respectively. Exemplary transaction details can include a transaction descriptor, a transaction amount, a transaction date, a transaction location, a merchant category code (or MCC) and/or other merchant information, without limitation. If the second payment device comprises an installment loan, for example, the installment loan can be created and/or issued to fund the selected financial transaction 214.

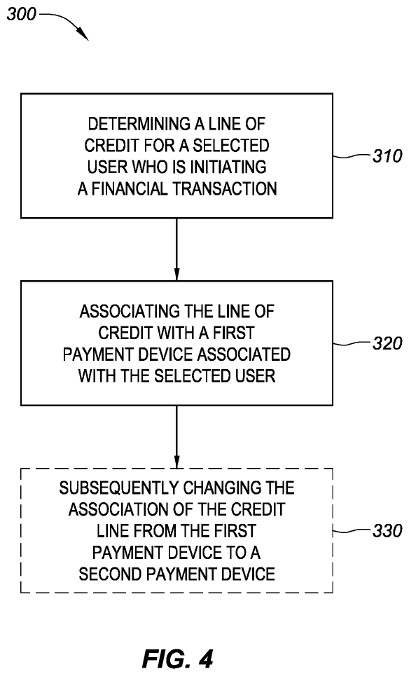

Additionally and/or alternatively, an exemplary financial transaction aggregation method 300 is illustrated in FIG. 4. The financial transaction aggregation method 300 advantageously can aggregate financial transactions via an intelligent dynamic line of credit. In selected embodiments, the financial transaction aggregation method 300 can comprise a computer-implemented method that can be executed, for example, via a processing system (or circuit) (not shown). An exemplary processing system is shown and described herein with reference to the computer (or server) system (or circuit) 1601 with reference to FIG. 3. Stated somewhat differently, the financial transaction aggregation method 300 can be incorporated into a financial transaction aggregation system (or circuit).

Turning to FIG. 4, the financial transaction aggregation method 300 can include determining (or extending) a line of credit (or credit line) for a selected payment device user, at 310. The selected payment device user, for example, can be in the process of initiating a financial transaction. In selected embodiments, the line of credit can be determined, at 310, in a dynamic manner and/or in real time as the selected payment device user initiates the financial transaction.

The line of credit can be determined, at 310, based upon one or more credit-determining factors. Exemplary credit-determining factors can include, but are not limited to, a credit score of the selected payment device user, a credit utilization level of the selected payment device user and/or a total of the assets of the selected payment device user. The total assets of the selected payment device user can be based, for example, upon bank accounts, cryptocurrency accounts and/or brokerage accounts associated with the selected payment device user.

Additionally and/or alternatively, the financial transaction aggregation method 300 can determine the line of credit, at 310, based upon a payment history for the selected payment device user and/or a credit history for the selected payment device user, without limitation. The payment history and/or the credit history can include the payment history and/or the credit history as reported by one or more third parties, such as a national credit reporting agency, such as Equifax, Experian and TransUnion, and/or a third party who previously extended credit to the selected payment device user. Optionally, the financial transaction aggregation method 300 can base the line of credit determination, at 310, upon the payment history and/or the credit history of the selected payment device user for one or more lines of credit previously established for the selected payment device user by the financial transaction aggregation method 300 itself.

The financial transaction aggregation method 300, at 320, is shown as associating the determined line of credit with a first payment device associated with the selected payment device user. Exemplary payment devices are discussed in more detail herein with reference to FIG. 1. In selected embodiments, the determined line of credit can be associated with the first payment device, at 320, as the selected payment device user initiates the financial transaction. Stated somewhat differently, the line of credit for the financial transaction can be extended to the selected payment device user in real time based upon receipt of a timely purchase authorization, credit authorization or other authorization from one or more of the payment devices associated with the selected payment device user.

The financial transaction aggregation method 300, in selected embodiments, optionally can associate the determined line of credit with the first payment device, at 320, based upon at least one credit-associating factors. Exemplary credit-associating factors can include an amount of the financial transaction, a credit authorization history (successful credit authorizations and/or failed credit authorizations) for the payment devices associated with the selected payment device user, and/or a payment history of the selected payment device user on the payment devices, without limitation.

The following example can help illustrate operation of the financial transaction aggregation method 300. In this example, the selected payment device user can initiate a purchase of a computer system for $2000 at an electronics store. The selected payment device user, for example, can initiate the computer system purchase via a first payment device, such as a credit card, that is associated with the financial transaction aggregation method 300. Stated somewhat differently, the computer system purchase can be initiated via the first payment device that embodies or is otherwise associated with an intelligent line of credit. The intelligent line of credit advantageously can be associated with one or more other payment devices of the selected payment device user for aggregating financial transactions.

Utilizing the intelligent line of credit, a purchase authorization, credit authorization or other authorization can be attempted at the time of the computer system purchase. The purchase authorization, credit authorization or other authorization can comprise an effort to extend a line of credit in the amount of $2000 to the selected payment device user. If the purchase authorization, credit authorization or other authorization succeeds, the line of credit in the amount of $2000 can be extended to the selected payment device user for consummating the computer system purchase. The line of credit then can be repaid via the first payment device or, as needed, via one or more of the other payment devices of the selected payment device user that are associated with the intelligent line of credit.

Since the computer system purchase is initiated via the first payment device that is associated with the intelligent line of credit in this example, the credit authorization can be attempted in an appropriate manner such as by swiping a magnetic strip of the first payment device and/or by reading an electronic Europay, MasterCard, and Visa (or EMV) chip embedded in the first payment device at a payment terminal. If the credit authorization succeeds, the financial transaction aggregation method 300 can approve the computer system purchase and extend the line of credit to the selected payment device user in the purchase amount of $2000. In other words, the financial transaction aggregation method 300 can determine the $2000 line of credit for the selected payment device user, at 310, and associate the determined $2000 line of credit with the first payment device associated with the selected payment device user, at 320. The extended line of credit thereby can be used to pay the electronics store for the purchased computer system.

The financial transaction aggregation method 300 likewise can initiate repayment of the determined $2000 line of credit via the first payment device upon receiving the credit authorization and otherwise finalize the financial transaction associated with the computer system purchase. In selected embodiments, the financial transaction aggregation method 300 can repay the determined $2000 line of credit in full via the first payment device without accruing any (additional) interest charge or other charge from the line of credit.

Alternatively, if the credit authorization based upon the first payment device does not succeed, the financial transaction aggregation method 300 still can approve the computer system purchase and extend the line of credit to the selected payment device user in the purchase amount of $2000. Stated somewhat differently, the above credit authorization can be repeated for one or more of the other payment devices of the selected payment device user that are associated with the intelligent line of credit. A second credit authorization, for instance, can be attempted at the time of the computer system purchase an effort to extend the line of credit in the amount of $2000 to the selected payment device user. The second credit authorization can be based upon at least one second (or different) payment device of the selected payment device user that is associated with the intelligent line of credit. If the second credit authorization succeeds, the line of credit in the amount of $2000 can be extended to the selected payment device user for consummating the computer system purchase. The line of credit then can be repaid via the second payment device of the selected payment device user that are associated with the intelligent line of credit.

The financial transaction aggregation method 300 thereby can approve the computer system purchase and extend the line of credit to the selected payment device user in the purchase amount of $2000. Stated somewhat differently, the financial transaction aggregation method 300 can determine the $2000 line of credit for the selected payment device user, at 310, and associate the determined $2000 line of credit with the second payment device of the selected payment device user that are associated with the intelligent line of credit, at 320. The extended line of credit thereby can be used to pay the electronics store for the purchased computer system.

The financial transaction aggregation method 300 likewise can initiate repayment of the determined $2000 line of credit via the second payment device that are associated with the intelligent line of credit upon receiving the second credit authorization and otherwise finalize the financial transaction associated with the computer system purchase. In selected embodiments, the financial transaction aggregation method 300 can repay the determined $2000 line of credit in full via the second payment device of the selected payment device user that are associated with the intelligent line of credit without accruing any (additional) interest charge or other charge from the line of credit.

The financial transaction aggregation method 300 still can approve the computer system purchase and extend the line of credit to the selected payment device user in the purchase amount of $2000 even if the second credit authorization based upon the second payment device does not succeed by repeating the above credit authorization for one or more of the other payment devices of the selected payment device user that are associated with the intelligent line of credit.

The selected payment device user can engage in other financial transactions after the computer system purchase is complete. For instance, the selected payment device user can later initiate a purchase of an appliance for $500 at a hardware store. The selected payment device user can initiate the appliance purchase via the first payment device or via a second, different payment device that is associated with the selected payment device user and/or the financial transaction aggregation method 300. If the first payment device is used, a credit authorization can be attempted on the first payment device in an effort to extend a line of credit in the amount of $500 to the selected payment device user at the time of the appliance purchase in the manner set forth in more detail above with reference to the exemplary computer system purchase.

Here, even if the credit authorization for the computer system purchase or the appliance purchase fails, the financial transaction aggregation method 300 still can extend a line of credit to the selected payment device user. The financial transaction aggregation method 300, for instance, can evaluate one or more credit-extension factors and, based upon the credit-extension factor evaluation, extend the line of credit to the selected payment device user and otherwise approve the underlying financial transaction. Exemplary credit-extension factors can include, but are not limited to, a credit score of the selected payment device user, a total credit utilization of the selected payment device user and/or a previous history of authorizations and line of credit repayments for the selected payment device user.

The financial transaction aggregation method 300 advantageously can enable the selected payment device user to repay the line of credit via one or more repayment options. The selected payment device user, for example, can choose to repay the line of credit for the underlying financial transaction via one or more repayment options, including an installment loan, an authorization on a separate debit card, credit card and/or other payment device, a transfer of funds from an account at a financial institution and/or a conversion of a cryptocurrency to a fiat currency suitable for repayment, without limitation.

In selected embodiments, the financial transaction aggregation method 300 can enable the selected payment device user to change the method of repayment for the line of credit after the purchase or other underlying financial transaction has been consummated. As shown in FIG. 4, for instance, the financial transaction aggregation method 300 optionally can subsequently change the association of the line of credit from the first payment device to a second payment device, at 330. Stated somewhat differently, the financial transaction aggregation method 300 can permit the selected payment device user to change the association of the line of credit from the first payment device to at least one second payment device associated with the selected payment device user.

The financial transaction aggregation method 300, for example, can cancel the requested credit authorization for the first payment device, preferably before the requested credit authorization has been finalized, and create a new credit authorization for the second payment device associated with the selected payment device user. Additionally and/or alternatively, the financial transaction aggregation method 300 can refund the finalized transaction amount to the first payment device and create a new credit authorization for the second payment device as a second (or subsequent) financial transaction in the manner discussed above. The financial transaction aggregation method 300 optionally can refund the finalized transaction amount to the first payment device and generate a new installment loan in the finalized transaction amount. In each case, any debit to the first payment device is settled, and the finalized transaction amount is transferred to the second payment device.

According to various embodiments, various functionality of the financial transaction revision method 100 and/or the financial transaction aggregation method 300 discussed herein can be performed by and/or with the help of one or more computers. Such a computer can be and/or incorporate, as just some examples, a personal computer, a server, a smartphone, a system-on-a-chip, and/or a microcontroller. Such a computer can, in various embodiments, run Linux, MacOS, Windows, or another operating system.

Such a computer can also be and/or incorporate one or more processors operatively connected to one or more memory or storage units, wherein the memory or storage may contain data, algorithms, and/or program code, and the processor or processors may execute the program code and/or manipulate the program code, data, and/or algorithms. Shown in FIG. 3 is an example computer employable in various embodiments of the present invention. Exemplary computer 1601 includes system bus 1603 which operatively connects two processors 1605 and 1607, random access memory (RAM) 1609, read-only memory (ROM) 1611, input and/or output (I/O) interfaces 1613 and 1615, storage interface 1617, and display interface 1619.

Storage interface 1617 in turn connects to mass storage 1621. Each of I/O interfaces 1613 and 1615 can, as just some examples, be a Universal Serial Bus (USB), a Thunderbolt, an Ethernet, a Bluetooth, a Long Term Evolution (LTE), a 5G, an IEEE 488, and/or other interface. Mass storage 1621 can be a flash drive, a hard drive, an optical drive, or a memory chip, as just some possibilities. Processors 1605 and 1607 can each be, as just some examples, a commonly known processor such as an ARM-based or x86-based processor.

Computer 1601 can, in various embodiments, include or be connected to a touch screen, a mouse, and/or a keyboard. Computer 1601 can additionally include or be attached to card readers, DVD drives, floppy disk drives, hard drives, memory cards, ROM, and/or the like whereby media containing program code (e.g., for performing various operations and/or the like described herein) may be inserted for the purpose of loading the code onto the computer.

In accordance with various embodiments of the present invention, a computer may run one or more software modules designed to perform one or more of the above-described operations. Such modules can, for example, be programmed using Python, Java, JavaScript, Swift, React, C, C++, C #, and/or another language. Corresponding program code can be placed on media such as, for example, DVD, CD-ROM, memory card, and/or floppy disk. It is noted that any indicated division of operations among particular software modules is for purposes of illustration, and that alternate divisions of operation may be employed.

Accordingly, any operations indicated as being performed by one software module can instead be performed by a plurality of software modules. Similarly, any operations indicated as being performed by a plurality of modules can instead be performed by a single module. It is noted that operations indicated as being performed by a particular computer can instead be performed by a plurality of computers. It is further noted that, in various embodiments, peer-to-peer and/or grid computing techniques may be employed.

It is additionally noted that, in various embodiments, remote communication among software modules may occur. Such remote communication can, for example, involve JavaScript Object Notation-Remote Procedure Call (JSON-RPC), Simple Object Access Protocol (SOAP), Java Messaging Service (JMS), Remote Method Invocation (RMI), Remote Procedure Call (RPC), sockets, and/or pipes.

Moreover, in various embodiments the functionality discussed herein can be implemented using special-purpose circuitry, such as via one or more integrated circuits, Application Specific Integrated Circuits (ASICs), or Field Programmable Gate Arrays (FPGAs). A Hardware Description Language (HDL) can, in various embodiments, be employed in instantiating the functionality discussed herein. Such an HDL can, as just some examples, be Verilog or Very High Speed Integrated Circuit Hardware Description Language (VHDL). More generally, various embodiments can be implemented using hardwired circuitry without or without software instructions. As such, the functionality discussed herein is limited neither to any specific combination of hardware circuitry and software, nor to any particular source for the instructions executed by the data processing system.

In selected embodiments, one or more of the features disclosed herein can be provided as a computer program product. The computer program product, for example, can be encoded on one or more non-transitory machine-readable storage media, such as magnetic, optical and/or electronic storage media of any kind and without limitation. As used herein, a phrase in the form of at least one of A, B, C and D herein is to be construed as meaning one or more of A, one or more of B, one or more of C and/or one or more of D.

The disclosed embodiments are susceptible to various modifications and alternative forms, and specific examples thereof have been shown by way of example in the drawings and are herein described in detail. It should be understood, however, that the disclosed embodiments are not to be limited to the particular forms or methods disclosed, but to the contrary, the disclosed embodiments are to cover all modifications, equivalents, and alternatives.

What is claimed is:

1. A computer-implemented method for extending an intelligent line of credit to aggregate financial transactions initiated via a plurality of payment devices associated with a payment device user, comprising:
determining a first line of credit in real time by a processing circuit at initiation of a first financial transaction with a third party via a first payment device associated with the payment device user; and
based upon receipt of a credit authorization from the first payment device,
associating the first line of credit with the first payment device via the processing circuit; and
transferring a payment from the first line of credit to the third party via the processing circuit,
wherein the first financial transaction with the third party is completed via the first line of credit.

2. The method of claim 1, wherein said determining the first line of credit includes basing a first credit line amount of the first line of credit upon a first financial transaction amount of the first financial transaction, and wherein said transferring the payment comprises transferring the payment in the first credit line amount from the first line of credit to the third party.

3. The method of claim 1, further comprising repaying the first line of credit via the processing circuit.

4. The method of claim 3, wherein said repaying the first line of credit comprises repaying the first line of credit in full without incurring any interest or other charges from the line of credit.

5. The method of claim 3, further comprising designating a funding source for said repaying the first line of credit.

6. The method of claim 5, wherein said designating the funding source includes designating at least one of the payment devices associated with the payment device user for said repaying the first line of credit.

7. The method of claim 6, wherein said designating the funding source includes designating the first payment device for said repaying the first line of credit.

8. The method of claim 5, further comprising changing the designated funding source for said repaying the first line of credit.

9. The method of claim 8, wherein said changing the designated funding source comprises changing the designated funding source for said repaying the first line of credit from the first payment device to a second payment device associated with the payment device user before finalization of the credit authorization from the first payment device, the method further comprising:
determining the first line of credit in real time by the processing circuit at initiation of the first financial transaction via the second payment device; and
based upon receipt of a credit authorization from the second payment device,
associating the first line of credit with the second payment device via the processing circuit; and
transferring the payment from the first line of credit to the third party via the processing circuit.

10. The method of claim 8, wherein said changing the designated funding source comprises changing the designated funding source for said repaying the first line of credit from the first payment device to a second payment device associated with the payment device user after finalization of the credit authorization from the first payment device, the method further comprising:
refunding the designated funding source for said repaying the first line of credit;
determining the first line of credit in real time by the processing circuit at initiation of the first financial transaction via the second payment device; and
based upon receipt of a credit authorization from the second payment device,
associating the first line of credit with the second payment device via the processing circuit; and
transferring a payment in the second credit line amount from the first line of credit to the third party via the processing circuit.

11. The method of claim 5, wherein said repaying the first line of credit comprises repaying the first line of credit via an installment loan, a second credit authorization on a second payment device associated with the payment device user, a third credit authorization on a third payment device not associated with the payment device user, a transfer of funds from an account at a financial institution, a conversion of a cryptocurrency to a fiat currency suitable for repayment of the first line of credit or a combination thereof.

12. The method of claim 1, wherein said determining the first line of credit includes extending the first line of credit upon receipt of the credit authorization from the first payment device.

13. The method of claim 1, further comprising:
receiving a credit denial for the first payment device;
initiating the first financial transaction via a second payment device associated with the payment device user via the processing circuit; and
based upon receipt of a credit authorization from the second payment device,
extending the first line of credit via the processing circuit in real time at said initiating the first financial transaction via the second payment device;
associating the first line of credit with the second payment device via the processing circuit; and
transferring the payment in the first credit line amount from the first line of credit to the third party via the processing circuit.

14. The method of claim 1, further comprising:
receiving a credit denial for the first payment device;
evaluating at least one credit-extension factor via the processing circuit; and
based upon said evaluating the at least one credit-extension factor,
extending the first line of credit the payment device user via the processing circuit; and
transferring the payment in the first credit line amount from the first line of credit to the third party via the processing circuit.

15. The method of claim 14, wherein said evaluating the at least one credit-extension factor includes evaluating a credit score of the payment device user, a total credit utilization of the payment device user, a previously history of credit authorizations of the payment device user or a line of credit repayments of the payment device user.

16. The method of claim 1, further comprising:
determining a second line of credit in real time by the processing circuit at initiation of a second financial transaction with a fourth party via the first payment device, a second credit line amount of the second line of credit being based upon a second financial transaction amount of the second financial transaction; and
based upon receipt of a second credit authorization from the first payment device,
associating the second line of credit with the first payment device via the processing circuit; and
transferring a payment in the second credit line amount from the second line of credit to the fourth party via the processing circuit,
wherein the second financial transaction with the third party is completed via the second line of credit.

17. The method of claim 1, further comprising:
determining a second line of credit in real time by the processing circuit at initiation of a second financial transaction with a fourth party via a second payment device associated with the payment device user, a second credit line amount of the second line of credit being based upon a second financial transaction amount of the second financial transaction; and
based upon receipt of a second credit authorization from the second payment device,
associating the second line of credit with the second payment device via the processing circuit; and
transferring a payment in the second credit line amount from the second line of credit to the fourth party via the processing circuit,
wherein the second financial transaction with the third party is completed via the second line of credit.

18. The method of claim 1, wherein said determining the first line of credit comprises determining the first line of credit based upon a credit report for the payment device user, a payment history for the payment device user for one or more lines of credit previously extended to the payment device user or a credit history for the payment device user for the one or more previously-extended lines of credit.

19. A computer program product for extending an intelligent line of credit to aggregate financial transactions initiated via a plurality of payment devices associated with a payment device user, the computer program product being encoded on one or more non-transitory machine-readable storage media and comprising:
instruction for receiving a credit determination at initiation of a first financial transaction with a third party via a first payment device associated with the payment device user;
instruction for determining a first line of credit in real time based upon receipt of a positive credit determination, a first credit line amount of the first line of credit being based upon a first financial transaction amount of the first financial transaction;
instruction for associating the first line of credit with the first payment device based upon the receipt of the positive credit determination; and
instruction for transferring a payment in the first credit line amount from the first line of credit to the third party based upon the receipt of the positive credit determination,
wherein the first financial transaction with the third party is completed via the first line of credit.

20. A system for extending an intelligent line of credit to aggregate financial transactions initiated via a plurality of payment devices associated with a payment device user, comprising:
at least one processing circuit being configured for determining a first line of credit in real time at initiation of a first financial transaction with a third party via a first payment device associated with the payment device user and, based upon receipt of a credit authorization from the first payment device, associating the first line of credit with the first payment device via the processing circuit and transferring a payment in the first credit line amount from the first line of credit to the third party via the processing circuit,
wherein a first credit line amount of the first line of credit is based upon a first financial transaction amount of the first financial transaction, and
wherein the first financial transaction with the third party is completed via the first line of credit.
